(19) United States
(12) Patent Application Publication
(10) Pub. No.: US 2016/0348844 A1
(43) Pub. Date: Dec. 1, 2016

(54) VALVE FOR A PRESSURIZED FLUID CYLINDER AND CORRESPONDING CYLINDER

(71) Applicant: L'AIR LIQUIDE, SOCIETE ANONYME POUR I'ETUDE ET I'EXPLOITATION DES PROCEDES GEORGES CLAUDE, Paris (FR)

(72) Inventors: Amélie CARRON, Paris (FR); Beatriz LOPEZ, Paris (FR); Christophe Roland REZEL, Savigny sur Orge (FR); Philippe RUDNIANYN, Villiers sur Orge (FR); Catherine VIVIER, Saint-Egrève (FR)

(73) Assignee: L'AIR LIQUIDE, SOCIETE ANONYME POUR I'ETUDE ET I'EXPLOITATION DES PROCEDES GEORGES CLAUDE, Paris (FR)

(21) Appl. No.: 15/112,757

(22) PCT Filed: Nov. 26, 2014
(86) PCT No.: PCT/FR2014/053044

§ 371 Date: Jul. 20, 2016

(30) Foreign Application Priority Data
Jan. 22, 2014 (FR) 1450524

(51) Int. Cl. F17C 13/02; G05B 19/042; G05B 19/406

(52) U.S. Cl. CPC F17C 13/025; G05B 19/406; G05B 19/042; F17C 2250/032; F17C 2250/0426; F17C 2250/0443; F17C 2250/0473; F17C 2250/036; F17C 2250/0491; F17C 2221/011

(57) ABSTRACT

The invention relates to a valve for a fluid cylinder, a first draw-off circuit comprising a member for regulating the flow and/or pressure of the drawn-off fluid, the valve comprising a manual control member and an electronic device displaying data relating to the fluid contained in a cylinder connected to the valve. The electronic display device comprises a data-acquisition, storage and processing member and at least one display; the valve comprises a sensor detecting the position of the control member; and the data-acquisition, storage and processing member is designed to control, in response to the receiving of an imposed flow and/or pressure signal, the displaying on the display of information concerning the flow and/or the pressure of the fluid imposed by the regulating member and/or the valve use mode

### CROSS REFERENCE TO RELATED APPLICATIONS

This application is a 371 of International PCT Application PCT/FR2014/053044 filed Nov. 26, 2014, which claims priority to French Patent Application No. 1450524 filed Jan. 22, 2014, the entire contents of which are incorporated herein by reference.

### BACKGROUND

The present invention relates to a valve for a pressurized fluid cylinder and to a corresponding cylinder.

### SUMMARY

The invention relates more particularly to a valve for a pressurized fluid cylinder, comprising a body provided with an end intended to be mounted in the orifice of a pressurized fluid cylinder, the body of the valve accommodating a first withdrawing circuit comprising a first, upstream end intended to communicate the storage volume of a pressurized fluid cylinder and a second, downstream end intended to be connected to a consumer of the withdrawn gas, the first withdrawing circuit comprising a member for regulating the flow rate and/or the pressure of the withdrawn fluid between the upstream end and the downstream end, the valve comprising a member for manually controlling the regulating member, the control member being mounted so as to be able to move relative to the body of the valve and cooperating with the regulating member to control the flow rate and/or pressure of fluid allowed to circulate from the upstream end to the downstream end depending on the position of the control member with respect to the body, the valve comprising an electronic device for indicating data relating to the fluid content in a cylinder connected to the valve, the electronic indicating device comprising a member for acquiring, storing and processing data and at least one data display connected to the member for acquiring, storing and processing data, the valve having a sensor for sensing the position of the member for manually controlling the regulating member, the position sensor being connected to the member for acquiring, storing and processing data in order to transmit to the latter a signal indicative of the fluid flow rate and/or pressure set by the regulating member, the member for acquiring, storing and processing data being configured to cause an information item relating to the fluid flow rate and/or pressure set by the regulating member and/or relating to the mode of use of the valve to be displayed on the display in response to the reception of this set flow rate and/or pressure signal.

The invention relates to a valve provided with an electronic device for indicating physical data relating to the content notably of pressurized gas in a pressurized fluid cylinder. The invention relates notably to a device known as an electronic digital pressure gage device. Reference may be made for example to the document FR2868160A1, which describes an example of such a device.

Such a device comprises a pressure sensor and an electronic logic which calculates and displays the data relating to the quantity of fluid and/or to autonomy.

In order to calculate and display such reliable autonomy information, the device has to take several successive pressure measurements before evaluating the flow rate selected by the valve user. This causes a calculating time which does not make it possible to immediately display a selected autonomy or withdrawing rate. Thirty to sixty seconds may be necessary, for example. In addition, this device also has an identical reaction time if the withdrawing parameters are changed (change in the selected withdrawing rate, etc.).

In addition, when the valve is used to supply oxygen to a medical ventilator (withdrawing rate set by the ventilator), the signal of pressure measured by the pressure gage undergoes a phase oscillation with the ventilation phases. On account of the great variety of ventilation modes, it is difficult to calculate or display a relevant information item.

The documents EP2110949A1, U.S. Pat. No. 6,098,646 and WO2012164240A1 describe devices for measuring the position of a selector via a plurality of sensors.

However, such devices have a relatively complex and expensive structure, notably as far as the calibration thereof is concerned.

The document U.S. Pat. No. 6,518,749 describes a detector for detecting a position magnetically. However, besides its cost, this device has the drawback of requiring the presence of (a) magnet(s) that is/are potentially problematic for the other electrical components.

It is an aim of the present invention to remedy all or some of the abovementioned drawbacks of the prior art.

To this end, the valve according to the invention, which is otherwise in accordance with the generic definition thereof given in the preamble above, is essentially characterized in that the sensor for sensing the position of the control member comprises a mechanism that meshes with the control member and a potentiometer, the mechanism having a movable part that forms a wiper of the potentiometer, the position sensor providing a voltage and/or resistance value determined depending on the position of the control member.

This makes it possible to rapidly and automatically indicate to the user that gas is being withdrawn, either on account of a medical ventilator being supplied, or on account of a leak.

Moreover, embodiments of the invention can include one or more of the following features:
the position sensor also comprises a capacitive system that measures an electrical capacitance between a fixed magnetic reference and a moving part connected to the movable part of the mechanism,
the member for manually controlling the regulating member is movable into a position known as the “closed” position corresponding to closure of the first withdrawing circuit, that is to say that the flow rate of fluid allowed to pass from the upstream end to the downstream end is zero,
the potentiometer of the sensor for sensing the position of the control member is calibrated by measuring the voltage or resistance value that it supplies corresponding to the position known as the “closed” position of the manual control member ensuring closure of the first withdrawing circuit, then by measuring the voltage or resistance value supplied by the potentiometer corresponding to an extreme position of the control member with respect to the closed position, the intermediate voltage or resistance values supplied by the potentiometer being attributed respectively to the intermediate positions of the control member,
the potentiometer of the sensor for sensing the position of the control member is calibrated by measuring the voltage or resistance value that it supplies corresponding to a position of the control member in which no pressure variation is measured by the pressure sensor for a given time, for example one to three minutes, this position being defined as being the closed position,
when the manual control member is in its closed position and the variation in the signal indicative of the fluid pressure within a cylinder is lower than a given variation threshold, the member for acquiring, storing and processing data is configured to cause a fixed information item relating to the pressure and/or quantity of fluid in the cylinder and/or to a history of these information items and/or an information item relating to a history of the use of the valve such as flow rate(s) withdrawn, history of the pressure measured, duration(s) of use, to be displayed on the display,
the valve has a pressure sensor intended to measure the pressure within the storage volume of a fluid cylinder connected to the valve, the pressure sensor being connected to the member for acquiring, storing and processing data in order to transmit to the latter a signal indicative of the measured fluid pressure, the member for acquiring, storing and processing data being configured to calculate and display on the display an information item relating to the autonomy or content of remaining fluid in response to the reception of this pressure signal,
at least one of the position sensor and the pressure sensor is of the electrical type and powered by a battery and/or an inductive system, said at least one sensor being powered discontinuously, the member for acquiring, storing and processing data being configured to ensure this discontinuous power supply when a measurement is taken,
the member for acquiring, storing and processing data is configured to calculate an information item relating to the autonomy or content of fluid over a given period of time of between one second and ten minutes and preferably between thirty seconds and six minutes, from the pressure signal measured by the pressure sensor, the member for acquiring, storing and processing data also being configured to compare this autonomy information calculated on the basis of the measured pressure signal with the theoretical autonomy information calculated from the variation in quantity or pressure set by the regulating member,
the member for acquiring, storing and processing data is configured to recalculate and display automatically an update of the information relating to the autonomy or content of fluid on receiving a signal from the position sensor indicating a change in fluid flow rate and/or pressure set by the regulating member via the control member,
the member for acquiring, storing and processing data is configured to recalculate and display automatically an update of the information relating to the autonomy or content of fluid on receiving a signal from the position sensor indicating a change in fluid flow rate and/or pressure set by the regulating member via the control member,
the sensor for sensing the position of the control member comprises a converter for converting a mechanical movement of the control member into an electrical signal that is exploitable by the member for acquiring, storing and processing data,
alternatively or in addition to the position sensor having a potentiometer, the sensor for sensing the position of the control member comprises a mechanism that meshes with the control member and an optical and/or digital encoder, the encoder providing a digital signal determined depending on the position of the control member,
when the manual control member is in its position known as the closed position and the variation in the signal indicative of the fluid pressure within a cylinder is greater than a given variation threshold, the member for acquiring, storing and processing data is configured to calculate an information item relating to the autonomy of remaining fluid from the measurement of the initial-pressure signal and the variation in this pressure signal provided by the pressure sensor, the member for acquiring, storing and processing data being configured to cause this calculated autonomy information item and/or an information item relating to the initial quantity or pressure of fluid in the cylinder to be displayed on the display,

The invention also relates to a pressurized fluid cylinder comprising a valve according to any one of the above or following features.

According to one possible particular feature, after the cylinder has been filled and before first withdrawal, the member for acquiring, storing and processing data is configured to cause a fixed information item relating to the fluid content in the cylinder to be displayed on the display until the position sensor transmits a signal indicative of a flow rate and/or the pressure of fluid withdrawn from the reservoir for a given time and/or corresponding to a given quantity of fluid.

The invention can also relate to any alternative device or method comprising any combination of the above or following features.

### BRIEF DESCRIPTION OF THE DRAWINGS

Further particular features and advantages will become apparent from reading the following description, which is given with reference to the figures, in which:

FIG. 1 shows a schematic and partial side view illustrating a valve mounted on a pressurized gas cylinder according to one possible exemplary embodiment of the invention,

FIG. 2 schematically and partially illustrates the structure and operation of a part of the valve from FIG. 1,

FIGS. 3 to 5 schematically and partially illustrate the structure and operation of three respective examples of position sensors of a valve according to the invention,

FIG. 6 schematically shows two curves illustrating examples of signals generated by one or more position sensors from FIG. 5,

FIGS. 7 and 8 schematically and partially illustrate the structure and operation of a fourth example and a fifth example, respectively, of a position sensor of the valve according to the invention,

FIG. 9 schematically shows an example of a pressure curve measured over time.

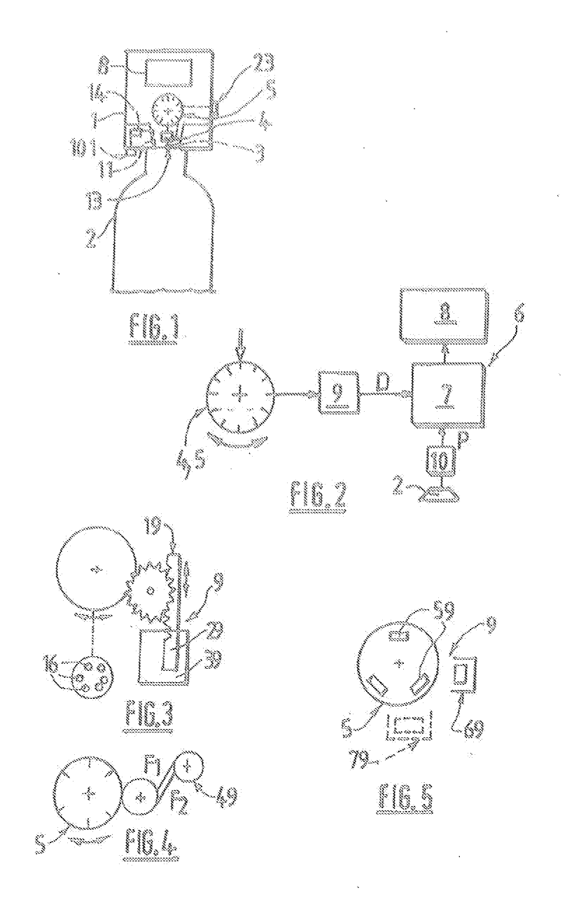

FIG. 1 schematically shows a pressurized gas cylinder 2 provided with a valve 1 that is able to implement the invention.

### DESCRIPTION OF PREFERRED EMBODIMENTS

The valve 1 comprises a body provided with an end intended to be mounted in the orifice of a pressurized fluid cylinder 2 (for example by screwing).

In a conventional manner, the body of the valve 1 accommodates a first withdrawing circuit 3 comprising a first, upstream end 13 communicating with the storage volume of the cylinder 2. The withdrawing circuit 3 comprises a second, downstream end 23 intended to be connected to a consumer of the withdrawn gas (for example a patient in the case of oxygen or some other medical gas).

The first withdrawing circuit 3 comprises a member 4 for regulating the flow rate and/or the pressure of the withdrawn fluid between the upstream end 13 and downstream end 23. This regulating member 4 is for example a flow rate regulator having calibrated orifices 16, making it possible to select a withdrawn gas flow rate (cf. the schematic depiction in FIG. 3). Of course, any other regulating member is conceivable, for example a valve with a proportional opening.

The valve 1 comprises a member 5 for manually controlling the member 4. The control member 5 is mounted so as to be able to move relative to the body of the valve 1 and cooperates with the regulating valve 4 to control the flow rate and/or pressure of fluid allowed to circulate depending on the position of the control member 5 with respect to the body of the valve. The control member 5 comprises for example a rotary hand wheel. Of course, any other appropriate system is conceivable (pivoting lever, etc.). For example, the control member 5 selects a calibrated orifice and/or controls a flow rate restriction valve depending on its position among a plurality of separate stable positions or a plurality of positions of a continuous movement. In particular the stable positions can be mechanically referenced by a hard point (for example via a detent system).

The valve 1 comprises an electronic device 6 for indicating data relating to the content of fluid in a cylinder 2 connected to the valve 1. The device can be of the type comprising a member 7 for acquiring, storing and processing data and at least one data display 8 connected to the member 7 for acquiring, storing and processing data. The member 7 for acquiring, storing and processing data comprises for example a computer and/or a microprocessor or any other equivalent system.

Of course, this device can have one or more data receiving members (via a wired and/or wireless connection) and also one or more data output members (via a wired and/or wireless connection).

The valve 1 has a sensor 9 for sensing the position of the member 5 for manually controlling the regulating member 4. The position sensor 9 is connected to the member 7 for acquiring, storing and processing data in order to transmit to the latter a signal indicative of the fluid flow rate and/or pressure set by the regulating member 4. The sensor 9 for sensing the position of the control member 5 comprises a converter for converting the mechanical movement of the control member into an electrical signal that is exploitable by the member 7 for acquiring, storing and processing data.

The detector is for example secured to a fixed part of the valve or, respectively, the control member, the detector outputting an electrical or digital signal determined depending on the position of the control member 5. This signal can be output in a wired and/or wireless manner.

As illustrated in FIG. 3, the sensor 9 for sensing the position of the control member 5 comprises a mechanism 19 that meshes with the control member 5 (for example a meshing and/or notching system) and a potentiometer 39. The mechanism has a moving part 29 (for example a wheel or a rod or a rack) that forms a wiper of the potentiometer 39. In this way, the position sensor 9 supplies a voltage and/or resistance value determined depending on the position of the control member 5.

In the example in FIG. 4, the sensor 9 for sensing the position of the control member 5 also comprises a mechanism that meshes with the control member 5 comprising an optical and/or digital encoder 49, for example a wired encoder (live wire and ground wire). The encoder 49 supplies a digital signal determined depending on the position of the control member 5. Depending on the position of the mechanism, one or more wires are live or short-circuited, forming a plurality of separate signals for characterizing different positions (for example 2ⁿ⁻¹ for a system having n wires).

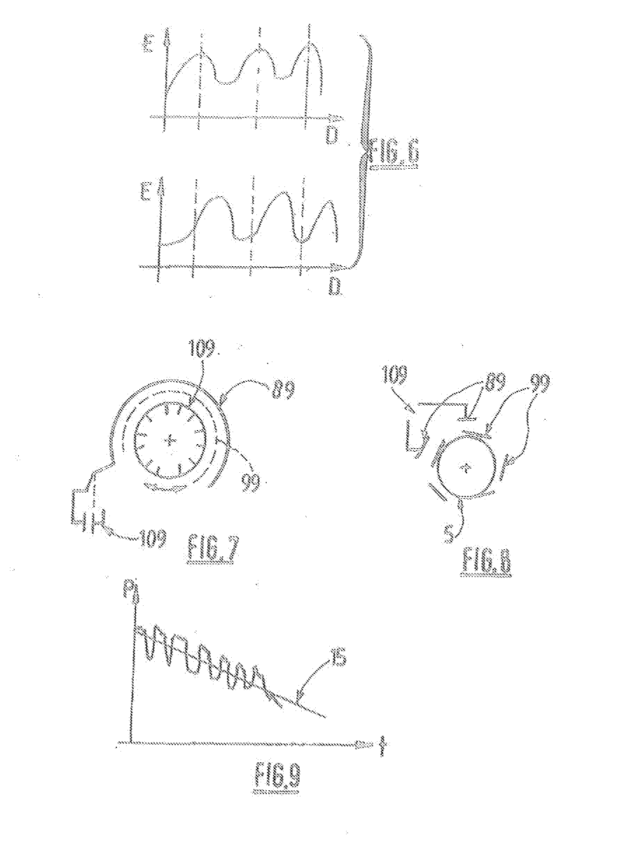

FIG. 5 illustrates another solution, in which the sensor 9 for sensing the position of the control member 5 comprises a magnetic system having at least one magnet 59 secured to the control member 5 and at least one detector 69, 79 for detecting the magnetic field of the at least one magnet 59. For example three magnets 59 are secured to the control member 5. If the control member 5 moves (such as by rotation), one detector 69 detects for example a magnetic field E depending on the movement D which oscillates and makes it possible to characterize a plurality of positions. When the device comprises a second detector 79 (or more), several separate signals can be exploited simultaneously in order to improve the detection of the separate positions.

As illustrated in FIGS. 7 and 8, the sensor 9 for sensing the position of the control member 5 can comprise a capacitive system 109 that measures an electrical capacitance between a fixed magnetic reference 89 and a moving part 99 connected to the control member 5.

All of these systems have the advantage of reliable detection without the need to provide electric wires linked to a moving part of the mechanism.

The potentiometer system and more generally each detection system can be calibrated easily during production.

For example, the potentiometer 39 or detector of the sensor 9 for sensing the position of the control member 5 can be calibrated by measuring the voltage or resistance value (or magnetic field and capacitance value) that it supplies corresponding to said “closed” position (zero flow rate). Next, it is possible to measure the voltage or resistance value supplied by the potentiometer 39 which corresponds to an extreme position of the control member 5 with respect to the closed position. The intermediate voltage or resistance values supplied by the potentiometer 39 are attributed respectively to the intermediate positions of the control member 5 between the closed position and the extreme position. (Likewise for the detection of some other physical variable, magnetic field, capacitance, etc., where the intermediate positions of the signal can be allocated respectively to the intermediate positions of the control member 5).

Alternatively or in addition, the potentiometer 39 of the sensor 9 for sensing the position of the control member 5 can be calibrated by measuring the voltage or resistance value that it supplies corresponding to a position of the control member 5 in which no pressure variation is measured by the pressure sensor 10 for a given time, for example one to three minutes. This position (this value of the signal) is defined as being the closed position of the circuit (zero flow rate). This way of defining the closed position can be applied to the other examples (magnetic field, capacitance, etc.).

Similarly, alternatively or in addition, a robot and/or operator can move the control member 5 to make different positions of the control member 5 correspond to the corresponding electrical values generated.

All or part of this calibration system, which is original per se, can also be applied to the other embodiments of the position sensor (capacitive sensor, magnetic sensor, etc.), independently of a sensor having a potentiometer. In other words, the invention can relate to a valve in which the different values of the signal output by the sensor 9 for sensing the position of the control member 5 (capacitive, magnetic or the like) are attributed respectively to different positions of the control member 5.

The manual control member 5 and/or the regulating member 4 may be able to move into a plurality of separate positions (which are or are not mechanically stable) that correspond to respective flow rate and/or pressure values of fluid allowed to pass from the upstream end 13 to the downstream end. According to one advantageous particular feature, when the manual control member 5 is disposed in an intermediate position between two respective adjacent flow rate and/or pressure values of fluid allowed to pass from the upstream end 13 to the downstream end 23, the member 7 for acquiring, storing and processing data is configured to select and display on the display 8 one or both of these adjacent values or an intermediate value between these two adjacent values or a range of values defined by these two adjacent values. Alternatively, the device displays no information, notably no figures when the manual control member 5 is disposed in an intermediate position between two adjacent values (in order to make the user react and correct his incorrect selection).

Preferably, the member 7 for acquiring, storing and processing data displays and/or signals the most critical or most unfavorable value for the user (wireless remote transmission or wired or audible transmission).

This makes it possible to ergonomically warn the user of incorrect manipulation by displaying relevant but disadvantageous information, obliging him to correct his selection.

For example, when the manual control member 5 is disposed in an intermediate position between two respective adjacent flow rate values, the member 7 for acquiring, storing and processing data is configured to calculate and display on the display 8 an information item relating to the autonomy or content of fluid remaining in the cylinder on the basis of the higher value of the two adjacent values.

Thus, if, for example, the user positions the control member 5 between the positions n liters per minute and n+1 liters per minute (n being an integer), the member 7 for acquiring, storing and processing data can be configured to calculate autonomy based on the withdrawn flow rate value of n+1 liters per minute (less autonomy than if it had been calculated with the value of n liters per minute).

Similarly, when the manual control member 5 is disposed in an intermediate position between two respective adjacent flow rate values, the member 7 for acquiring, storing and processing data can be configured to display on the display 8 an information item relating to the withdrawn flow rate set by the regulating member 4 that corresponds to the lower value of the two adjacent values. Thus, if, for example, the user positions the control member 5 between the positions n liters per minute and n+1 liters per minute (n being an integer), the member 7 for acquiring, storing and processing data can be configured to display on the display 8 an information item based on the withdrawn flow rate value of n liters per minute (the lower flow rate, which may for example be less than the medical prescription). This, in addition to or instead of an alarm, will cause the user to react so as to correct the flow rate selection.

The device can be configured to deliver in this case a fluid flow rate corresponding to one of the two adjacent values, notably the displayed value.

Preferably, when the manual control member 5 is disposed in an intermediate position between two respective adjacent flow rate and/or pressure values of fluid allowed to pass from the upstream end 13 to the downstream end 23, the regulating member 4 is designed to allow the withdrawal of fluid at a non-zero flow rate between said two respective adjacent flow rate and/or pressure values, notably the value displayed.

Alternatively, when the manual control member 5 is disposed in an intermediate position between two respective adjacent flow rate and/or pressure values of fluid allowed to pass from the upstream end 13 to the downstream end 23, the regulating member 4 is designed to allow the withdrawal of fluid at a flow rate equal to one of said two respective adjacent flow rate and/or pressure values.

In addition, when the regulating member 4 makes it possible to vary the flow rate or pressure continuously (in a non-discrete manner), the member 7 for acquiring, storing and processing data can be configured to display the actual flow rate value selected.

As illustrated in FIG. 2, the valve preferably also has a pressure sensor 10 intended to measure the pressure within the storage volume of the cylinder 2. The pressure sensor 10 is connected to the member 7 for acquiring, storing and processing data in order to transmit to the latter (in a wired and/or wireless manner) a signal indicative of the fluid pressure measured, notably in real time or periodically.

The member 7 for acquiring, storing and processing data can be configured to calculate and display on the display 8 an information item relating to the autonomy or content of remaining fluid in response to the reception of this pressure signal delivered by the sensor 10.

Preferably, the member 5 for manually controlling the regulating member 4 is movable into a position known as the “closed” position corresponding to closure of the first withdrawing circuit 3. In other words, the flow rate of fluid allowed to pass from the upstream end 13 to the downstream end 23 is zero. When the manual control member 5 is in its closed position and the variation in the signal indicative of the fluid pressure within a cylinder 2 is lower than a given variation threshold (for example equivalent to a pressure drop of 10 mbar/min (0.05 l/min) measured by the pressure sensor 10), the member 7 for acquiring, storing and processing data is preferably configured to cause a fixed information item relating to the pressure and/or quantity of fluid in the cylinder 2 to be displayed on the display 8.

In other words, the device detects that the cylinder 12 is not being emptied and displays for example an information item relating to its content.

As illustrated in FIG. 1, the valve 1 preferably comprises a second withdrawing circuit 11, for example separate from the first withdrawing circuit 3, which bypasses the flow rate and/or pressure regulating member 4 of the first withdrawing circuit 3.

If need be, this second withdrawing circuit 11 can have a portion in common with the first withdrawing circuit 3.

This second withdrawing circuit 11 is provided for example to supply a gas at a regulated pressure (via a pressure relief valve 14). For example, the second withdrawing circuit 11 supplies a variable or fixed pressure f of around 3 to 10 bar to a user appliance. For example, the second withdrawing circuit 11 has an outlet connection 101 (for example via a toothed connector) that can be connected to a medical ventilator in order to supply oxygen thereto.

This second withdrawing circuit 11 can supply gas from the cylinder 2 independently of the first withdrawing circuit 3. Thus, when the manual control member 5 is in its closed position and the variation in the signal indicative of the fluid pressure within a cylinder 2 (measured by the pressure sensor 10) is greater than a given variation threshold (for example 25 mbar per minute), the member 7 for acquiring, storing and processing data can detect withdrawal of fluid via the second withdrawing circuit 11 or, if this second withdrawing circuit 11 is not being used, a possible leak of fluid.

The member 7 for acquiring, storing and processing data can, if need be, cause an information item relating to withdrawal via the second withdrawing circuit 11 and or relating to a leak (warning signal) to be displayed on the display 8 or to be output (wirelessly, in a wired manner or audibly).

In particular, when the manual control member 5 is in its position known as the closed position and the variation in the signal indicative of the fluid pressure within a cylinder is greater than a given variation threshold (for example 25 mbar per minute), the member 7 for acquiring, storing and processing data is configured to detect at least one characteristic of the form of the variation in fluid pressure in the cylinder on account of the withdrawal via the second withdrawing circuit 11.

The at least one characteristic comprises for example: a periodic character of the variation in pressure or quantity, the frequency of the variation in pressure or quantity, the level of variation in pressure or quantity, etc.

As illustrated schematically in FIG. 9, this makes it possible to instantaneously detect, at the end of two to three pressure oscillations, for example periodic withdrawal corresponding to a gas supply to a respiratory ventilator. Specifically, even if the gas withdrawn does not pass through the flow rate regulator 4, the flow rate is regulated directly by a ventilator and depends on the patient's breathing. This flow rate thus delivered is not constant but oscillates over time (depending on the patient's breathing).

The member 7 for acquiring, storing and processing data can be configured to detect (recognize) a drop in pressure characteristic of ventilation using the following principle:
measuring the pressure signal in a close periodic manner (for example every 0.5 to two seconds, notably every second),
identifying a signal of the square wave type with a frequency of five to twenty-five square waves (respirations) per minute.

In order to calculate the remaining gas autonomy from such a signal, the member 7 for acquiring, storing and processing data can be configured to measure the pressure drop over the optima in order to deduce therefrom the equivalent rate of decrease (cf. reference 15 in FIG. 9). Alternatively or in addition, the member 7 for acquiring, storing and processing data can be configured to work out an average drop in pressure over a relatively long time (several minutes, for example ten minutes) so as to remove image inaccuracies.

In the event that this pressure signal does not correspond to a ventilation signal (for example a continuous decreasing variation), the member 7 for acquiring, storing and processing data can determine that it is a leak or incorrect use of the gas, and can signal this in the same way.

Thus, in this case, the simultaneous detection of the closed position (scale “0”=“zero” for example) at the position detector 5 and a pressure drop, it is then possible to instantaneously and automatically detect the mode of use of the cylinder 2. A rapid autonomy calculation algorithm described below is not used, and an autonomy calculation appropriate for this manner of withdrawal can be carried out by the member 7 for acquiring, storing and processing data.

This autonomy calculation algorithm based on the pressure measurement 10 can then be initiated automatically.

In addition, when the manual control member 5 is in its closed position and the variation in the signal indicative of the fluid pressure within a cylinder 2 is greater than a given variation threshold, the member 7 for acquiring, storing and processing data can be configured to calculate an information item relating to the autonomy of remaining fluid from the measurement of the initial-pressure signal and the variation in this pressure signal provided by the pressure sensor 10. The member 7 for acquiring, storing and processing data can notably be configured to cause this calculated autonomy information item and/or an information item relating to the initial quantity or pressure of fluid in the cylinder 2 to be displayed on the display 8.

The pressure sensor 10 can be situated for example at the upstream end of the first withdrawing circuit 3 and/or at the second withdrawing circuit 11.

In addition, the member 7 for acquiring, storing and processing data can be configured to cause an information item relating to the fluid flow rate and/or pressure set by the regulating member 4 to be displayed on the display 8 in response to the reception of this set flow rate and/or pressure signal.

The member 7 for acquiring, storing and processing data can thus be configured to receive both the signal of pressure P measured by the pressure sensor 10 and the flow rate and/or pressure D signal supplied by the position sensor 9. The member 7 for acquiring, storing and processing data can thus be programmed to calculate an information item relating to the autonomy of remaining fluid from these two information items, the autonomy of remaining fluid being determined for example by calculating, from the initial pressure measured, the theoretical decrease over time in pressure or the quantity of gas generated by the withdrawing flow rate and/or pressure D set by the regulating member 4.

The information relating to the autonomy or content of fluid remaining in the cylinder 2 can be expressed in time remaining (or, respectively, in quantity remaining) by dividing the initial pressure measured by the pressure sensor 10 (or, respectively, a quantity of gas flowing) by the theoretical variation in pressure set by the regulating member 4 (or, respectively, the variation in quantity set by the regulating member (4)), by a formula for example of the type: Time remaining=Initial pressure/variation in pressure set (or, respectively: Time remaining=Remaining fluid content/variation in quantity set).

The theoretical variations in quantity or pressure can be calculated for example via the perfect gas equation PV=nRT or real gas equation PV=ZnRT units), where P is the pressure measured, V the known volume of the cylinder, n the quantity, R the perfect gas constant and T the temperature measured or approximated to the ambient temperature measured, Z the compressibility factor presumed to be known (table or calculation). Similarly, the conversions between pressure and quantity can be calculated via the perfect gas equation or any other equivalent formula, the volume of the cylinder 2 being known and entered in the member 7 for acquiring, storing and processing data and the temperature can be measured by an ambient external sensor or calculated or entered or approximated.

The dynamic pressure measurement can make it possible to adjust the display of the effective flow rate withdrawn and/or the autonomy displayed more precisely, if necessary.

Similarly, the member 7 for acquiring, storing and processing data can be configured to recalculate and display automatically an update of the information relating to the autonomy or content of fluid on receiving a signal from the position sensor 9 indicating a change in fluid flow rate and/or pressure set by the regulating member 4 via the control member 5.

In addition, the member 7 for acquiring, storing and processing data can be configured to have a guarantee seal function indicating that the cylinder 2 has not been used after being filled. Thus, before first withdrawal, the member 7 for acquiring, storing and processing data can cause a fixed information item relating to the fluid content in the cylinder 2 (and/or the information item of the “cylinder full” type) to be displayed on the display 8 until the position sensor 9 transmits a signal indicative of a flow rate and/or the pressure of fluid withdrawn from the reservoir 2 for a given time and/or corresponding to a given quantity of fluid (for example 20 liters of gas withdrawn). This detection can be carried out or completed by the information provided by the pressure sensor 10.

Although the invention is relatively simple and inexpensive, it is easy to see that it makes it possible to display flow rate and autonomy information more quickly.

The invention applies advantageously to pressurized gas cylinders, notably cylinders containing pressurized oxygen.

1.-12. (canceled)

13. A valve for a pressurized fluid cylinder, comprising a body provided with an end configured to be mounted in an orifice of a pressurized fluid cylinder, the body of the valve accommodating a first withdrawing circuit comprising a first, upstream end intended to communicate a storage volume of a pressurized fluid cylinder and a second, downstream end intended to be connected to a consumer of the withdrawn gas, the first withdrawing circuit comprising a member for regulating the flow rate and/or the pressure of the withdrawn fluid between the upstream end and the downstream end , the valve comprising a member for manually controlling the regulating member, the control member being mounted so as to be able to move relative to the body of the valve and cooperating with the regulating member to control the flow rate and/or pressure of fluid allowed to circulate from the upstream end to the downstream end depending on the position of the control member with respect to the body, the valve comprising an electronic device for indicating data relating to the fluid content in a cylinder connected to the valve, the electronic indicating device comprising a member for acquiring, storing and processing data and at least one data display connected to the member for acquiring, storing and processing data, the valve having a sensor for sensing the position of the member for manually controlling the regulating member, the position sensor being connected to the member for acquiring, storing and processing data in order to transmit to the latter a signal indicative of the fluid flow rate and/or pressure set by the regulating member, the member for acquiring, storing and processing data being configured to cause an information item relating to the fluid flow rate and/or pressure set by the regulating member and/or to the mode of use of the valve to be displayed on the display in response to the reception of this set flow rate and/or pressure signal, wherein the sensor for sensing the position of the control member comprises a mechanism that meshes with the control member and a potentiometer, the mechanism having a movable part that forms a wiper of the potentiometer, the position sensor providing a voltage and/or resistance value determined depending on the position of the control member.

14. The valve of claim 13, wherein the position sensor further comprises a capacitive system that measures an electrical capacitance between a fixed magnetic reference and a moving part connected to the movable part of the mechanism.

15. The valve of claim 13, wherein the member for manually controlling the regulating member is movable into a position known as the “closed” position corresponding to closure of the first withdrawing circuit.

16. The valve of claim 15, wherein the potentiometer of the sensor for sensing the position of the control member is calibrated by measuring the voltage or resistance value that it supplies corresponding to the position known as the “closed” position of the manual control member ensuring closure of the first withdrawing circuit, then by measuring the voltage or resistance value supplied by the potentiometer corresponding to an extreme position of the control member with respect to the closed position, the intermediate voltage or resistance values supplied by the potentiometer being attributed respectively to the intermediate positions of the control member.

17. The valve of claim 15, wherein the potentiometer of the sensor for sensing the position of the control member is calibrated by measuring the voltage or resistance value that it supplies corresponding to a position of the control member in which no pressure variation is measured by the pressure sensor for a given time, for example one to three minutes, this position being defined as being the closed position.

18. The valve of claim 15, wherein when the manual control member is in its closed position and the variation in the signal indicative of the fluid pressure within a cylinder is lower than a given variation threshold, the member for acquiring, storing and processing data is configured to cause a fixed information item relating to the pressure and/or quantity of fluid in the cylinder and/or to a history of these information items and/or an information item relating to a history of the use of the valve such as flow rate(s) withdrawn, history of the pressure measured, duration(s) of use, to be displayed on the display).

19. The valve as of claim 13, further comprising a pressure sensor configured to measure the pressure within the storage volume of a fluid cylinder connected to the valve, the pressure sensor being connected to the member for acquiring, storing and processing data in order to transmit to the latter a signal indicative of the measured fluid pressure, the member for acquiring, storing and processing data being configured to calculate and display on the display an information item relating to the autonomy or content of remaining fluid in response to the reception of this pressure signal.

20. The valve of claim 19, wherein at least one of the position sensor and the pressure sensor is of the electrical type and powered by a battery and/or an inductive system, said at least one sensor being powered discontinuously, the member for acquiring, storing and processing data being configured to ensure this discontinuous power supply when a measurement is taken.

21. The valve of claim 19, wherein the member for acquiring, storing and processing data is configured to calculate an information item relating to the autonomy or content of fluid over a given period of time of between one second and ten minutes, from the pressure signal measured by the pressure sensor, the member for acquiring, storing and processing data also being configured to compare this autonomy information calculated on the basis of the measured pressure signal with the theoretical autonomy information calculated from the variation in quantity or pressure set by the regulating member.

22. The valve of claim 21, wherein the member for acquiring, storing and processing data is configured to recalculate and display automatically an update of the information relating to the autonomy or content of fluid on receiving a signal from the position sensor indicating a change in fluid flow rate and/or pressure set by the regulating member via the control member.

23. A pressurized fluid cylinder, comprising a valve as claimed in claim 13.

24. The cylinder of claim 23, wherein after the cylinder has been filled and before first withdrawal, the member for acquiring, storing and processing data is configured to cause a fixed information item relating to the fluid content in the cylinder to be displayed on the display) until the position sensor transmits a signal indicative of a flow rate and/or the pressure of fluid withdrawn from the reservoir for a given time and/or corresponding to a given quantity of fluid.
